(19) United States
(12) Patent Application Publication
(10) Pub. No.: US 2026/0184341 A1
(43) Pub. Date: Jul. 2, 2026

(54) AUTONOMOUS DRIVING BEHAVIOR DECISION-MAKING METHOD, DRIVING DECISION-MAKING EQUIPMENT, AND COMPUTER-READABLE STORAGE MEDIUM

(71) Applicant: UBTECH ROBOTICS CORP LTD, Shenzhen (CN)

(72) Inventors: Jun Ye, Shenzhen (CN); Jinbing Xiong, Shenzhen (CN); Jianxin Pang, Shenzhen (CN); Jichao Jiao, Shenzhen (CN); Chuangpeng Guo, Shenzhen (CN)

(21) Appl. No.: 19/330,835

(22) Filed: Sep. 17, 2025

(30) Foreign Application Priority Data
Dec. 30, 2024 (CN) 2024119933447

(51) Int. Cl. B60W 60/00; G06N 7/01

(52) U.S. Cl. CPC B60W 60/0011; G06N 7/01; B60W 2556/10

(57) ABSTRACT

An autonomous driving behavior decision-making method, a driving decision-making equipment, and a computer-readable storage medium are provided. By using a driving behavior policy network and a driving cost evaluation network trained based on an adaptive dynamic planning technology to perform a Monte Carlo tree search algorithm according to a real-time driving environment state of a target vehicle, the adaptive dynamic planning technology is integrated into each decision-making stage of the Monte Carlo tree search algorithm to guide the Monte Carlo tree search algorithm to focus on the effective searches associated with the high-value decisions for reducing the workload of invalid searches, the loss burden of calculation resources, and the time loss so as to improve the efficiency and the accuracy of the decision-making of the Monte Carlo tree search algorithm.

### CROSS REFERENCE TO RELATED APPLICATIONS

The present disclosure claims priority to Chinese Patent Application No. 2024119933447, filed Dec. 30, 2024, which is hereby incorporated by reference herein as if set forth in its entirety.

### TECHNICAL FIELD

The present disclosure relates to self-driving technology, and particularly to an autonomous driving behavior decision-making method, a driving decision-making equipment, and a computer-readable storage medium.

### BACKGROUND

With the development of intelligent automobiles and driving assistance technology, autonomous driving, as the advanced stage of assisted driving, has seemed to be an important means of the solutions for people's travels in the future, and has become a new round of research focus and hot topics around the world. Especially in recent years, autonomous driving technology has flourished and has made milestone progress in the history of the development of human transportation.

At present, an autonomous driving technology architecture is mainly divided into three main modules: an environmental perception module, a driving decision planning module, and a control execution module. In which, the driving decision planning module can decide the optimal driving behavior of an autonomous driving vehicle in a dynamic and complex environment based on the external environment state and the internal state of the vehicle perceived by an environment perception module to provide to the control execution module for execution, thereby meeting preset requirements on the basis of ensuring driving safety. Therefore, the performance of driving decision planning will directly affect the final autonomous driving effect. It is worth noting that the existing autonomous driving behavior decision-making methods are difficult to take into account decision efficiency, environmental adaptability, and decision interpretability at the same time in complex and dynamic environments, and cannot provide driving behavior decision-making results that are adaptable to the vehicle driving environment and have good decision interpretability to the autonomous driving vehicle in a quick manner.

### BRIEF DESCRIPTION OF DRAWINGS

In order to more clearly illustrate the technical solution of the present disclosure, the drawings used in the embodiments of the present disclosure are introduced as follows. It should be noted that the following drawings only illustrate certain embodiments of the present disclosure and should not be regarded as limiting the scope of protection of the present disclosure. In each of the drawings, similar components are denoted with similar reference numerals.

FIG. 1 is a schematic diagram of the composition of a driving decision-making equipment according to an embodiment of the present disclosure.

FIG. 2 is a flow chart of part one of an autonomous driving behavior decision-making method according to an embodiment of the present disclosure.

FIG. 3 is a flow chart of sub-steps included in step S220 of FIG. 2.

FIG. 4 is a flow chart of part two of an autonomous driving behavior decision-making method according to an embodiment of the present disclosure.

FIG. 5 is a schematic diagram of an adaptive dynamic planning structure according to an embodiment of the present disclosure.

FIG. 6 is a flow chart of sub-steps included in step S250 of FIG. 4.

### DETAILED DESCRIPTION

In order to make the objects of the embodiments of the present disclosure more clear, the technical solutions in the embodiments of the present disclosure will be clearly and completely described below with reference to the drawings in the embodiments of the present disclosure. Apparently, the described embodiments are part of the embodiments of the present disclosure, not all of the embodiments. The components of the embodiments of the present disclosure that are described and illustrated in the drawings herein may generally be arrent and designed in a variety of different configurations.

Therefore, the following detailed description of the embodiments of the present disclosure provided in the drawings is not intended to limit the scope of the present disclosure, but merely represent the selected embodiments of the present disclosure. Based on the embodiments in the present disclosure, all other embodiments obtained by those skilled in the art without creative work are within the scope of the present disclosure.

It should be noted that similar reference numerals and letters denote similar items in the following drawings, and therefore, once an item is defined in one drawing, it will not be further defined or explained in subsequent drawings.

In the description of the present disclosure, it is to be understood that the orientational or positional relationship indicated by the terms “center”, “upper”, “lower”, “left”, “right”, “vertical”, “horizontal”, “inner”, “outer”, or the like is based on the orientational or positional relationship shown in the drawings, that in the usual placement of the product related to the present disclosure, or that commonly understood by those skilled in the art, and is merely for the convenience of describing the present disclosure and simplifying the description, rather than indicating or implying that the device or component referred to must have a particular orientation, be constructed and operated in a particular orientation, hence should not be understood as limitations to the present disclosure.

In the descriptions of present disclosure, it should also be noted that unless otherwise specified and defined, the terms “setting”, “installation”, “interconnection”, and “connection” should be interpreted in a broad sense as, for example, a fixed connection, a removable connection, or an integral connection; or as a mechanical connection or an electrical connection; otherwise, a direct connection, an indirect connection through an intermediate medium, or an internal connection between two elements. For those skilled in the art, the specific meaning of the foregoing terms can be understood according to the specific situation.

In the description of present disclosure, it should be noted that relational terms such as “first” and “second” are used only to distinguish one entity or operation from another entity or operation, and do not necessarily require or imply the existence of any actual relationship or sequence between these entities or operations. Moreover, the terms “comprising”, “including” or any other variation thereof are intended to encompass non-exclusive inclusion such that a process, method, article or apparatus (device) comprising a series of elements includes not only those elements, but also includes other elements not explicitly listed or inherent to the process, method, article or apparatus. Without further limitation, an element limited by the sentence “comprising a . . . ” does not preclude the existence of additional identical elements in a process, method, article or apparatus that includes the element. For those of ordinary skill in the art, the specific meanings of the above-mentioned terms in the present disclosure can be understood according to the specific condition.

The inventor has found through unremitting researches that the existing autonomous driving behavior decision-making methods mainly use three decision-making ideas: preset rules, search algorithms, and reinforcement learning. In which, the preset rule-based autonomous driving behavior decision-making method cannot effectively predict the behavior of other traffic participants in complex driving environments; the search algorithm-based autonomous driving behavior decision-making method can find better decision paths through global search and has a certain degree of decision-making interpretability because the observable process of global search, while often has the problems of high computational complexity and insufficient real-timeness, which is difficult to achieve fast and effective decision-making functions especially when facing a large-scale state space; and the reinforcement learning-based autonomous driving behavior decision-making method has certain environmental adaptability and can make fast decisions, while has a high dependence on the quality and the scale of training data and does not have strong decision-making interpretability because the given decisions are difficult to be explained reasonably.

In this case, in order to solve the foregoing problems, the embodiments of present disclosure provide an autonomous driving behavior decision-making method, a driving decision-making equipment, and a computer-readable storage medium to achieve a fast, robust and highly interpretable driving behavior decision-making function in the complex driving environment having considered other traffic participants.

Some embodiments of the present disclosure will be described in detail below with reference to the drawings. The following embodiments and the features therein may be combined with each other while there is no confliction therebetween.

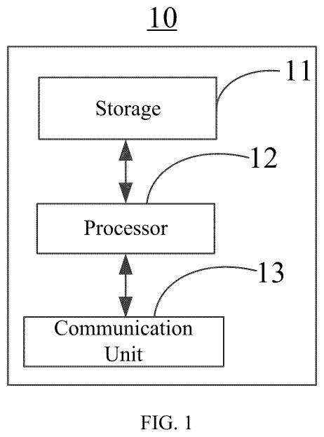

FIG. 1 is a schematic diagram of the composition of a driving decision-making equipment 10 according to an embodiment of the present disclosure. As shown in FIG. 1, in this embodiment, the driving decision-making equipment 10 may communicate with an autonomous driving vehicle equipped with an autonomous driving system to obtain driving environment state information of the autonomous driving vehicle in real time, and make quick and reliable decisions of the optimal driving action of the autonomous driving vehicle in a complex driving environment, thereby facilitating the autonomous driving system of the autonomous driving vehicle to operate the vehicle according to the decided optimal driving action so as to meet preset requirements on the basis of ensuring driving safety. In this process, the driving environment state information is used as the relative position relationship, relative posture relationship, relative speed change relationship, relative acceleration change relationship, or other information between the autonomous driving vehicle as well as other static targets (e.g., lane lines, road boundaries, and green belts) and other traffic participants (e.g., general vehicles and pedestrians) in the corresponding driving environment. The driving behavior decision (i.e., the optimal driving action) given by the driving decision-making equipment 10 may involve information of the corresponding autonomous driving vehicle such as the motion acceleration, steering angle, and braking degree, thereby directly affecting the motion state of the vehicle. The driving decision-making equipment 10 may be integrated with the autonomous driving vehicle that requires driving behavior decisions. In this case, the driving decision-making equipment 10 is the on-board device of the autonomous driving vehicle and is part of the autonomous driving system. The driving decision-making equipment 10 may also be a computer device independent of the autonomous driving vehicle, for example, a server, an external computer, or the like.

In this embodiment, the driving decision-making equipment 10 may include a storage 11, a processor 12, and a communication unit 13. In which, the components of the storage 11, the processor 12 and the communication unit 13 are directly or indirectly electrically connected to each other to realize data transmission or interaction. For example, the components of the storage 11, the processor 12 and the communication unit 13 may be electrically connected to each other through one or more communication buses or signal lines.

In this embodiment, the storage 11 may be, but not limited to, a random access memory (RAM), a read only memory (ROM), a programmable read only memory (PROM), erasable programmable read-Only memory (EPROM), electrical erasable programmable read-only memory (EEPROM), or the like. In which, the storage 11 is used for storing computer programs, and the processor 12 can execute the computer programs correspondingly after receiving execution instructions.

In this embodiment, the processor 12 may be an integrated circuit chip with signal processing capability. The processor 12 may be a general purpose processor including at least one of a central processing unit (CPU), a graphics processing unit (GPU), a network processor (NP), a digital signal processor (DSP), an application specific integrated circuit (ASIC), a field-programmable gate array (FPGA) or other programmable logic devices, discrete gate, transistor logic device, and discrete hardware component. The general purpose processor may be a microprocessor or the processor may also be any conventional processor that may implement or execute the methods, steps, and the logical block diagrams disclosed in the embodiments of the present disclosure.

In this embodiment, the communication unit 13 is configured to establishing a communication connection between the driving decision-making equipment 10 and other electronic devices through a network, and for sending/receiving data through the network, where the network includes a wired communication and a wireless communication network.

In this embodiment, the driving decision-making equipment 10 may store a specific computer program related to autonomous driving behavior decision-making functions in the storage 11 in advance, and enable the processor 12 to execute the specific computer program stored by the storage 11 accordingly, so that in a Monte Carlo tree search based on the real-time vehicle driving environment state, the adaptive dynamic planning technology is integrated into each decision-making stage of the Monte Carlo tree search algorithm to guide the Monte Carlo tree search algorithm to focus on the effective searches associated with the high-value decisions for reducing the workload of invalid searches, the loss burden of calculation resources, and the time loss so as to improve the efficiency and the accuracy of the decision-making of the Monte Carlo tree search algorithm, thereby achieving a fast, robust and highly interpretable driving behavior decision-making function in the complex driving environment having considered other traffic participants through flexibly combining the highly interpretable Monte Carlo tree search algorithm (because each decision-making stage of the Monte Carlo tree search algorithm including “selection”, “extension”, “rehearsal” and “traceback” is observable) and the highly environment adaptable adaptive dynamic planning technology (because the adaptive dynamic planning technology can adapt to the changes in the dynamic traffic environment by considering the real-time feedback mechanism for vehicle driving environment information so as to perform model adaptive learning optimization).

It should be noted that FIG. 1 is merely a schematic diagram of the composition of the driving decision-making equipment 10 which may include more or fewer components than shown in FIG. 1, or have a different configuration than shown in FIG. 1. Each component shown in FIG. 1 may be implemented using hardware, software, or a combination of both.

In the present disclosure, in order to ensure that the driving decision-making equipment 10 can achieve a fast, robust and highly interpretable driving behavior decision-making function in the complex driving environment having considered other traffic participants, an autonomous driving behavior decision-making method is provided. The autonomous driving behavior decision-making method is described in detail as below.

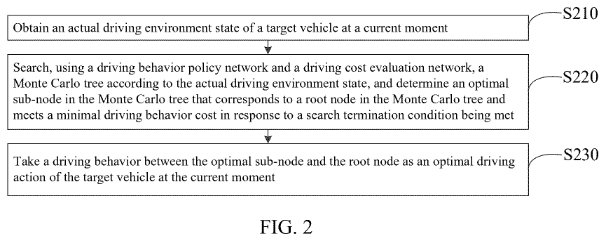

FIG. 2 is a flow chart of part one of an autonomous driving behavior decision-making method according to an embodiment of the present disclosure. As shown in FIG. 2, in this embodiment, the autonomous driving behavior decision-making method may include the following steps.

S210: obtaining an actual driving environment state of a target vehicle at a current moment.

In this embodiment, the target vehicle is an autonomous driving vehicle communicating with the driving decision-making equipment 10. The actual driving environment state records information such as the relative position relationship and relative posture relationship of the target vehicle with other surrounding static targets and other traffic participants at the current moment.

S220: searching, using a driving behavior policy network and a driving cost evaluation network, a Monte Carlo tree according to the actual driving environment state, and determining an optimal sub-node in the Monte Carlo tree that corresponds to a root node in the Monte Carlo tree and meets a minimal driving behavior cost in response to a search termination condition being met.

In this embodiment, the driving behavior policy network and the driving cost evaluation network belong to the same adaptive dynamic planning structure. The driving behavior policy network is configured to estimate the driving action in the driving environment state at any control moment so as to obtain the estimated driving behavior corresponding to the driving environment state (i.e., a driving behavior estimation result); and the driving cost evaluation network is configured to predict the driving behavior cost based on the driving environment state and an estimated driving behavior at any control moment so as to obtain the overall driving behavior cost (which is obtained by accumulating the comprehensive driving cost generated in all the control moments over a period of time in the future, where the total number of the control moments involved in the period of time in the future is fixed) generated over a period of time in the future when the vehicle operates according to the corresponding estimated driving behavior in the driving environment state. During the training and optimization of the network models of the driving behavior policy network and the driving cost evaluation network, the real-time feedback mechanism for the vehicle driving environment information may be considered by taking “minimizing the driving behavior cost predicted by the driving cost evaluation network” as the target of model optimization to train the adaptive dynamic planning structure that the driving behavior policy network and the driving cost evaluation network belong to, thereby ensuring that the driving behavior policy network can adapt to various complex traffic environments. At the same time, the driving behavior estimation result outputs by the driving behavior policy network for any driving environment state have sufficient accuracy and reliability, and can arrive at the destination efficiently while ensuring the safety of the vehicle, while the driving cost evaluation network can also accurately evaluate the driving behavior cost caused by any driving environment state and any driving behavior estimation results in a fixed time period of the future.

In this process, for the driving cost evaluation network, the driving behavior cost it evaluates may be expressed using function expression equations of:

$$\{ \begin{matrix}J ( {s}_{t 0} , {u}_{t 0} ) = {\sum }_{l = t 0}^{t 0 + T} U ( {s}_{l} , {u}_{l} ) \\ U ( {s}_{l} , {u}_{l} ) = {ω}_{s} {J}_{s} ( {s}_{l} ) + {ω}_{c} {J}_{c} ( {s}_{l} ) + {ω}_{p} {J}_{p} ( {s}_{l} ) + {ω}_{u} {J}_{u} ( {s}_{l} , {u}_{l} )\end{matrix} ;$$

where, sₗ represents the driving environment state at the control moment l, uₗ represents the vehicle driving action (or the estimated driving behavior) at the control moment l, J(sₜ₀,uₜ₀) represents the driving behavior cost caused by the driving environment state sₜ₀ and the vehicle driving action uₜ₀ at the control moment t0 during a fixed time period of the future (which includes the control moments of the total number T+1), U(sₗ,uₗ) represents the comprehensive driving cost matching the driving environment state sₗ and the vehicle driving action uₗ, Jₛ(sₗ) represents the safety cost of the driving environment state sₗ, J_{c}(sₗ) represents the comfort cost of the driving environment state sₗ, Jₚ(sₗ) represents the passability cost of the driving environment state sₗ, and Jᵤ(sₗ,uₗ) represents the secondary quadratic cost matching the driving environment state sₗ and the vehicle driving action uₗ, and ωₛ, ω_{c}, ωₚ, and ωᵤ are all the cost comprehensive weights.

In which, the safety cost is inversely correlated with the distance between the vehicle and its surrounding objects (including static targets and other traffic participants). For example, if the distance between the vehicle and a surrounding object exceeds a certain distance threshold, the safety cost caused by the object alone to the vehicle is zero; if the distance between the vehicle and the surrounding object is larger than 0 but less than or equal to the distance threshold, the safety cost caused by the object alone to the vehicle may be represented by the reciprocal of the distance; and if the distance between the vehicle and the surrounding object is 0, the safety cost caused by the object alone to the vehicle may be expressed as infinity. The comfort cost is positively correlated with the change rate of the acceleration of the vehicle, which represents the smoothness of the movement of the vehicle, where the larger the change rate of the acceleration, the larger the corresponding comfort cost. The passability cost is correlated to the distance of the vehicle to the destination, which represents the target orientation of the vehicle driving

$${J}_{u} ( {s}_{l} , {u}_{l} ) = {s}_{l}^{T} {Qs}_{l} + {u}_{l}^{T} {Ru}_{l} ,$$

action. The secondary quadratic cost may be expressed as where Q and R are both custom weights. In one embodiment, if the driving environment state of a certain vehicle indicates that there are a plurality of objects around the vehicle, the safety cost corresponding to the driving environment state will be obtained by adding up the safety cost caused by each of the objects to the vehicle.

In this embodiment, after obtaining the actual driving environment state of the target vehicle at the current moment, the driving decision-making equipment 10 will call the trained driving behavior policy network and the driving cost evaluation network to realize the flexible combination between the adaptive dynamic planning technology and each decision-making stage of the Monte Carlo tree search algorithm by using the output value of the driving behavior policy network (i.e., the driving behavior estimation result output for the driving environment state represented by each node in the Monte Carlo tree) as the guidance information while using the output value of the driving cost evaluation network (i.e., the driving behavior cost output for the driving environment state and the driving behavior estimation results of each node in the Monte Carlo tree) to represents the value function result in the Monte Carlo tree algorithm during the Monte Carlo tree search based on the actual driving environment state, so that the corresponding Monte Carlo tree search algorithm focuses on the effective searches associated with the high-value decisions for reducing the workload of invalid searches, the loss burden of calculation resources, and the time loss so as to improve the efficiency and the accuracy of the decision-making of the Monte Carlo tree search algorithm.

Therefore, during the Monte Carlo tree search according to the actual driving environment state, all nodes in the constructed Monte Carlo tree each represent a driving environment state. The root node in the Monte Carlo tree represents the actual driving environment state, and the initial driving behavior cost of each of the nodes in the Monte Carlo tree in the first access (i.e., when the actual access number is 1) may be directly assessed by the driving cost evaluation network based on the driving behavior estimation result and the driving environment state of the node, where the driving behavior estimation result of each of the nodes in the Monte Carlo tree are estimated by the driving behavior policy network based on the driving environment state of the node.

At the same time, during the Monte Carlo tree search, the driving decision-making equipment 10 will confirm whether the current search is the last one when a search is completed by detecting whether the search meets a search termination condition (e.g., the total number of searches reach a preset number, or the total search time reaches a preset time). In which, if the current search does not meet the search termination condition, it is indicated that the Monte Carlo tree search is not the last search. At this time, the driving decision-making equipment 10 will continue to perform the next Monte Carlo tree search based on the Monte Carlo tree obtained by the Monte Carlo tree search until the search termination condition is eventually met.

In the case that the Monte Carlo tree search meets the search termination condition, it is indicated that the Monte Carlo tree search is the last one, and the driving decision-making equipment 10 will select the child nodes, with the purpose of “ensuring the minimization of the corresponding driving behavior cost”, from the target Monte Carlo tree obtained after the Monte Carlo tree search is completed, thereby obtaining the optimal child node of the root node (i.e., the child node of the root node that has the lowest actual driving behavior cost in the target Monte Carlo tree). At this time, the driving environment state represented by the optimal child node of the root node is the ideal driving environment state expected to obtain at the next control moment of the current moment.

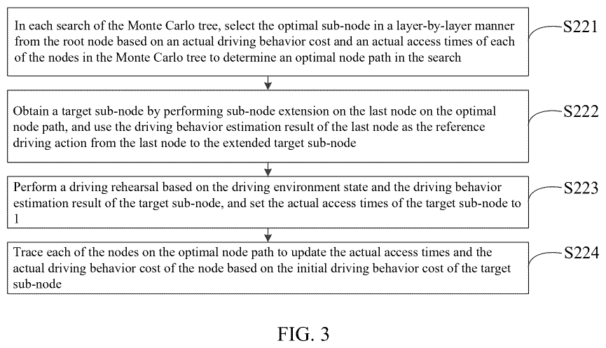

FIG. 3 is a flow chart of sub-steps included in step S220 of FIG. 2. As shown in FIG. 3, step S220 may include sub-steps S221-S224 to integrate the adaptive dynamic planning technology into each decision-making stage of the Monte Carlo tree search algorithm for performing the effective searches associated with the high-value decisions for reducing the workload of invalid searches, the loss burden of calculation resources, and the time loss so as to improve the efficiency and the accuracy of the decision-making of the Monte Carlo tree search algorithm.

S221: in each search of the Monte Carlo tree, selecting the optimal sub-node in a layer-by-layer manner from the root node based on an actual driving behavior cost and actual access times of each of the nodes in the Monte Carlo tree to determine an optimal node path in the search.

In this embodiment, in the Monte Carlo tree constructed based on the actual driving environment state, the actual driving behavior cost of each node in the Monte Carlo tree in the first access (i.e., when the actual access number is 1) is the initial driving behavior cost of the corresponding node. For each “select” stage during the Monte Carlo tree search, the driving decision-making equipment 10 will use the UCB (Upper Confidence Bound) algorithm to select, with the purpose of “ensuring the minimization of the cost and the value between the actual driving behavior of each of the nodes on the corresponding node path” and use a reference driving action of each of the nodes (i.e., the driving behavior estimation result of the corresponding node) as a selection guide, based on the actual driving behavior cost and the actual access times of each of the existing nodes, the optimal child node in a layer-by-layer manner from the root node in the current Monte Carlo tree, thereby forming the optimal node path during the Monte Carlo tree search. In which, any two adjacent nodes on the optimal node path meet a parent-child node relationship, and the driving behavior between each non-root node on the optimal node path and its parent node is obtained by adding a preset action noise (e.g., Gaussian noise) to the reference driving action of the corresponding parent node, thereby balancing the strategy selection relationship between “utilization” and “exploration” through superimposing the action noise on the reference driving action, while enhancing the path diversity of the optimal node path.

S222: obtaining a target sub-node by performing sub-node extension on the last node on the optimal node path, and using the driving behavior estimation result of the last node as the reference driving action from the last node to the extended target sub-node.

In this embodiment, in each “extension” stage of the Monte Carlo tree search, the driving decision-making equipment 10 may use the driving behavior estimation result of the last node on the optimal node path as the reference driving action between the last node and the new extended node to predict the future environmental state based on the driving environment state of the last node and the reference driving action, thereby obtaining the target sub-node by expanding based on the current Monte Carlo tree so as to provide diversified path selection for the subsequent “rehearsal” stage and “traceback” stage. In this manner, the effectiveness of search is improved to reduce the search workload, the computing resource loss burden, and time loss caused by invalid search, which improves the decision efficiency and decision accuracy of the Monte Carlo tree search algorithm.

S223: performing a driving rehearsal based on the driving environment state and the driving behavior estimation result of the target sub-node, and setting the actual access times of the target sub-node to 1.

In this embodiment, in each “rehearsal” stage of the Monte Carlo tree search, the driving decision-making equipment 10 may use the driving behavior estimation result and driving environment state of the target child node to perform the driving rehearsal simulation from the target child node until a simulation termination condition is met. At this time, the actual access number of the target child node may be set to 1, and the driving cost evaluation network may be called to evaluate the driving behavior cost matching the driving behavior estimation result and driving environment state of the target child node for taking as the initial driving behavior cost of the target child node.

S224: tracing each of the nodes on the optimal node path to update the actual access times and the actual driving behavior cost of the node based on the initial driving behavior cost of the target sub-node.

In this embodiment, in each “traceback” stage in the Monte Carlo tree search, the driving decision-making equipment 10 may add the actual access number of each node on the optimal node path by one based on the initial driving behavior cost of the newly expanded target child node in the order in reverse to the arrangement order of the nodes on the optimal node path, thereby obtaining the actual access number of each node on the optimal node path after the Monte Carlo tree search is completed. At the same time, the actual driving behavior cost of each node on the optimal node path may be updated based on equation q=q′+ (q_{L}−q′)/N, thereby ensuring that subsequent searches can more effectively select low-cost (i.e., high-value) node paths, so that the Monte Carlo tree search algorithm focuses on the effective searches associated with the high-value decisions. In which, q represents the actual driving behavior cost of the corresponding node after update, q′ represents the actual driving behavior cost of the corresponding node before update, N represents the actual access number of the corresponding node after update, and q_{L} represents the initial driving behavior cost of the newly expanded target child node.

Therefore, in this embodiment, by performing the foregoing sub-steps S221-S224, it integrates the adaptive dynamic planning technology into each decision-making stage of the Monte Carlo tree search algorithm for performing the effective searches associated with the high-value decisions for reducing the workload of invalid searches, the loss burden of calculation resources, and the time loss so as to improve the efficiency and the accuracy of the decision-making of the Monte Carlo tree search algorithm.

S230: taking a driving behavior between the optimal sub-node and the root node as an optimal driving action of the target vehicle at the current moment.

In this embodiment, after the driving decision-making equipment 10 determines the optimal child node of the root node from the target Monte Carlo tree that meeting the search termination conditions, it may extract the driving behavior between the root node and the corresponding optimal child node from the target Monte Carlo tree to take as the optimal driving action of the target vehicle in the complex traffic environment of the current moment, thereby achieving a fast, robust and highly interpretable driving behavior decision-making function.

Therefore, in this embodiment, by executing the foregoing steps S210-S230, in a Monte Carlo tree search based on the real-time vehicle driving environment state, the adaptive dynamic planning technology is integrated into each decision-making stage of the Monte Carlo tree search algorithm to guide the Monte Carlo tree search algorithm to focus on the effective searches associated with the high-value decisions for reducing the workload of invalid searches, the loss burden of calculation resources, and the time loss so as to improve the efficiency and the accuracy of the decision-making of the Monte Carlo tree search algorithm, thereby achieving a fast, robust and highly interpretable driving behavior decision-making function in the complex driving environment having considered other traffic participants through flexibly combining the highly interpretable Monte Carlo tree search algorithm and the highly environment adaptable adaptive dynamic planning technology.

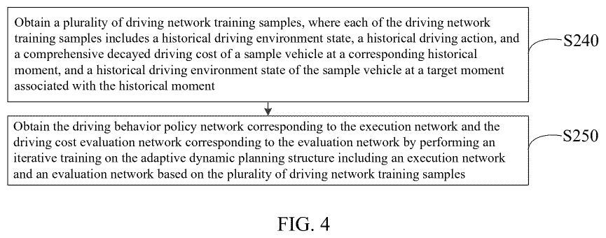

FIG. 4 is a flow chart of part two of an autonomous driving behavior decision-making method according to an embodiment of the present disclosure. As shown in FIG. 4, in this embodiment, compared with the autonomous driving behavior decision-making method shown in FIG. 2, steps S240-S250 are further included to ensure that the driving behavior policy network and the driving cost evaluation network can perform model adaptive learning optimization based on the real-time feedback mechanism for the vehicle driving environment information, thereby improving the network reliability and network robustness of the driving behavior policy network and the driving cost evaluation network in a complex driving environment.

S240: obtaining a plurality of driving network training samples, where each of the driving network training samples includes a historical driving environment state, a historical driving action, and a comprehensive decayed driving cost of a sample vehicle at a corresponding historical moment, and a historical driving environment state of the sample vehicle at a target moment associated with the historical moment.

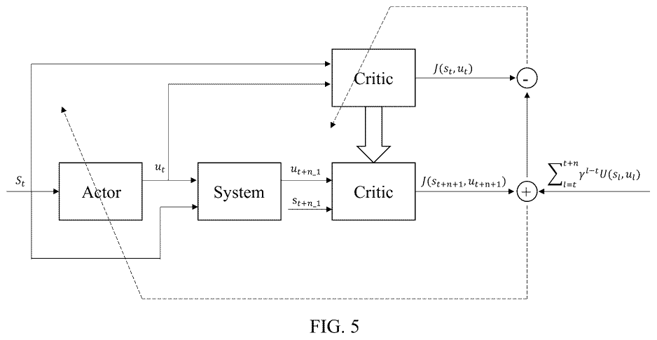

FIG. 5 is a schematic diagram of an adaptive dynamic planning structure according to an embodiment of the present disclosure. As shown in FIG. 5, in this embodiment, the adaptive dynamic planning structure may include an execution network, a dynamic system, and two evaluation networks. In which, the execution network corresponds to the driving behavior policy network, the evaluation network corresponds to the driving cost evaluation network, and the dynamic system is configured to infer the output action uₜ₊ₙ₊₁ at the target control moment t+n+1 based on the input state sₜ and the output action uₜ of the execution network at the control moment t, so that one of the two evaluation networks is responsible for a driving behavior cost evaluation of the input state sₜ and the output action uₜ alone, and the other of the evaluation networks is responsible for the driving behavior cost evaluation of the input state sₜ₊ₙ₊₁ and the output action uₜ₊ₙ₊₁ alone, and then the comprehensive decayed driving cost

$${\sum }_{l = t}^{t + n} {γ}^{l - t} U ( {s}_{l} , {u}_{l} )$$

from the control moment t to the control moment t+n is introduced from the exterior to perform a network optimization and adjustment, thereby achieving the model training optimization effect of the adaptive dynamic planning structure. In which, n represents a preset first number (which may be 0, 2, 3, or 5), and γ represents the discount factor of the evaluation network.

On this basis, each driving network training sample obtained by the driving decision-making equipment 10 for the driving behavior policy network and the driving cost evaluation network must include the historical driving environment state, historical driving action and comprehensive decayed driving cost of the corresponding sample vehicle at the corresponding historical moment, and the historical driving environment state of the sample vehicle at the target moment associated with the historical moment. In which, the sample vehicle may be the above-mentioned target vehicle or other autonomous driving vehicles. Individual driving network training sample corresponds to individual historical time points (i.e., moment). There is a preset first number of control moments between the target time of each driving network training sample and the corresponding historical moment (for example, for the historical moment t, the corresponding target moment is t+n+1), and the comprehensive decayed driving cost included in each driving network training sample is the sum (for example, for the historical moment t, the corresponding comprehensive decayed driving cost is

$${\sum }_{l = t}^{t + n} {γ}^{l - t} U ( {s}_{l} , {u}_{l} )$$

) of the respective comprehensive driving cost decays (for example, for the historical moment t, the comprehensive driving cost decay of the control moment l after the historical moment is γ^{l-t}U(sₗ,uₗ) of a preset second number of control moments (including the historical moment) of the sample vehicle since the corresponding historical moment, where the preset second number is obtained by adding one to the preset first number.

It should be noted that the driving decision-making equipment 10 may construct a data pool of fixed capacity for the target vehicle. The driving decision-making equipment 10 will collect the real-time driving environment state and the real-time driving actions of the target vehicle to construct driving network training samples to add to the data pool while deleting the oldest driving network training samples stored in the data pool, so that the respective driving network training sample stored in the data pool can effectively reflect the dynamic traffic environment changes of the target vehicle, thereby batch sampling the samples (for the driving behavior policy network and the driving cost evaluation network) from the data pool to perform model adaptive learning optimization.

S250: obtaining the driving behavior policy network corresponding to the execution network and the driving cost evaluation network corresponding to the evaluation network by performing an iterative training on the adaptive dynamic planning structure including an execution network and an evaluation network based on the plurality of driving network training samples.

In this embodiment, for the adaptive dynamic planning structure, the network function of the execution network may be described as

$$u ( {s}_{t} ) = {W}_{a}^{T} σ ( {s}_{t} ) ,$$

where σ(⋅) represents the hidden layer activation function (e.g., the tanh activation function) of the execution network, Wₐ represents the network weight between the hidden layer and the output layer of the execution network. In order to consider the executor output saturation characteristics during actual task execution, the output layer of the execution network may also be trained using the activation function (e.g., the tanh activation function). The network function of the evaluation network may be described as

$$J ( {s}_{t} , {u}_{t} ) = ξ {W}_{c}^{T} σ ( {s}_{t} , {u}_{t} ) ,$$

where σ(⋅) represents the hidden layer activation function (e.g., the tanh activation function) of the evaluation network, W_{c} represents the network weight between the hidden layer and the output layer of the evaluation network, ξ represents the learning coefficient of the evaluation network. In order to ensure that the network function and the function expression equation of the above-mentioned driving behavior cost maintain a positive effect, the output layer of the evaluation network may be trained using ReLu activation function. In which, there are multiple iterative optimizations of the evaluation network are during one iterative training of the execution network.

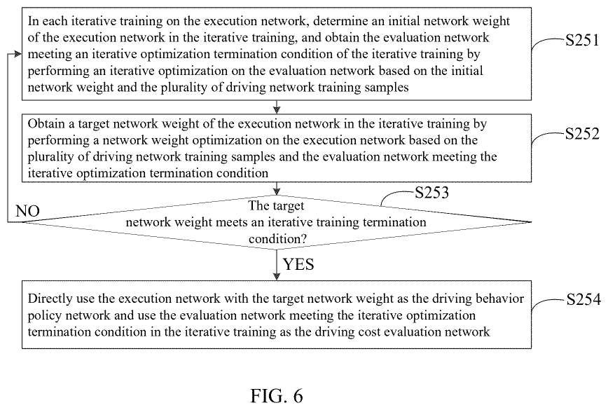

FIG. 6 is a flow chart of sub-steps included in step S250 of FIG. 4. As shown in FIG. 6, in this embodiment, step S250 may include sub-steps S251-S254 to ensure that the final optimized driving behavior policy network and driving cost evaluation network can effectively adapt to the changes in the dynamic traffic environment, and ensure that the driving behavior estimation result output by the corresponding driving behavior policy network for any driving environment state has sufficient accuracy and reliability. At the same time, the corresponding driving cost evaluation network can also accurately evaluate the driving behavior cost caused by any driving environment state and any driving behavior estimation result in a fixed time period of the future.

S251: in each iterative training on the execution network, determining an initial network weight of the execution network in the iterative training, and obtaining the evaluation network meeting an iterative optimization termination condition of the iterative training by performing an iterative optimization on the evaluation network based on the initial network weight and the plurality of driving network training samples.

In this embodiment, the initial network weight of the execution network in the first iterative training may be generated using a random seed algorithm. The initial network weight of the execution network in the non-first iterative training is the target network weight finally determined by the last iterative training of the non-first iterative training. In each iterative training of the execution network, the network iterative optimization of the evaluation network may be expressed using equations of:

$$\{ \begin{matrix}{J}_{j + 1} ( {s}_{t} , {u}_{t} ) = {\sum }_{l = t}^{t + n} U ( {s}_{l} , {u}_{l} ) + {γ}^{n + 1} {J}_{j} ( {s}_{t + n + 1} , u ( {s}_{t + n + 1} ) ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$

where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, U(sₜ,uₜ) represents the comprehensive driving cost matching the historical driving environment state sₜ and the historical driving action uₗ, Jₛ(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state sₜ and the historical driving action uₜ, ωₛ, ω_{c}, ωₚ, and ωᵤ are comprehensive cost weights; Jⱼ₊₁ (sₜ,uₜ) represents the driving behavior cost predicted by the evaluation network after the j+1-th iterative optimization according to the historical driving environment state sₜ and the historical driving action uₜ, u(sₜ₊₂₊₁) represents an estimated driving behavior predicted by the execution network according to the historical driving environment state sₜ₊ₙ₊₁, and Jⱼ(sₜ₊ₙ₊₁,u(sₜ₊ₙ₊₁)) represents the driving behavior cost predicted by the evaluation network after the j-th iterative optimization according to the historical driving environment state sₜ₊ₙ₊₁ and the estimated driving behavior u(sₜ₊ₙ₊₁).

At the same time, in each iterative training of the execution network, the evaluation network adopts the same iterative optimization termination condition (e.g., the corresponding iterative optimization times is equal to the preset optimization times, or the actual loss function value of the evaluation network after optimization is less than a preset value), thereby realizing multiple iterative optimizations of the evaluation network in a nest manner in one iterative training of the execution network. In which, it should be noted that the actual iterative optimization times of the evaluation network in different iterative trainings of the execution network can be different.

Therefore, in one iterative training of the execution network, the step “obtaining the evaluation network meeting the iterative optimization termination condition of the iterative training by performing the iterative optimization on the evaluation network based on the initial network weight and the plurality of driving network training samples” may include:
determining a reference network weight of the evaluation network in each iterative optimization on the evaluation network during the iterative training on the execution network;
obtaining a target network weight of the evaluation network in the iterative optimization by performing a network weight update on the evaluation network based on the reference network weight, the initial network weight, and the plurality of driving network trained samples;
determining whether the target network weight meets the iterative optimization termination condition; and
suspending a next iterative optimization and outputting the evaluation network with the target network weight in response to determining that the target network weight meets the iterative optimization termination condition; and performing the next iterative optimization on the evaluation network in response to determining that the target network weight not meets the iterative optimization termination condition; where the reference network weight of the evaluation network in the next iterative optimization is the target network weight in the iterative optimization.

In which, the reference network weight used in the first iterative optimization of the evaluation network during the first iterative training of the execution network may be set to a zero matrix. The reference network weight used by the first iterative optimization of the evaluation network during the non-first iterative training of the execution network may also be set to a zero matrix. In order to improve the iterative optimization efficiency of the evaluation network, the expected network weight of the evaluation network that meets the iterative optimization termination conditions in any iterative training (corresponding to the execution network) may be assigned to the reference network weight of the first iterative optimization (corresponding to the evaluation network) in the next iterative training.

In the i-th iterative training of the execution network, the update process of the network weight of the j+1-th iterative optimization of the evaluation network may be expressed using equations of:

$$\{ \begin{matrix}{W}_{c , j + 1} = {W}_{c , j} + {α}_{c} \frac{\partial {e}_{j}}{\partial {W}_{c}} \\ {e}_{j} = {\sum }_{l = t}^{t + n} {γ}^{l - t} U ( {s}_{l} , {u}_{i} ( {s}_{l} \vert {W}_{a} ) ) + {γ}^{t + n + 1} J ( {s}_{t + n + 1} , {u}_{i} ( {s}_{t + n + 1} \vert {W}_{a} ) \vert {W}_{c} ) - J ( {s}_{t} , {u}_{i} ( {s}_{t} \vert {W}_{a} ) \vert {W}_{c} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix}$$

where, W_{c,j+1} represent the target network weight of the j+1-th iterative optimization of the evaluation network during the L-th iterative training of the execution network; W_{c,j} represent the target network weight of the j-th iterative optimization of the evaluation network during the i-th iterative training of the execution network, α_{c} represents the learning rate of the evaluation network, W_{c} represents the network weight of the evaluation network, γ represent the discount factor of the evaluation network, sₜ represents the historical driving environment state at the historical moment t, uₜ represents the historical driving action at the historical moment t, sₜ₊ₙ₊₁ represents the historical driving environment state of the target moment associated with the historical moment t, n represents the preset first number, uᵢ(sₜ|Wₐ) represents the estimated driving behavior predicted by the execution network according to the historical driving environment state S using the initial network weight Wₐ during the i-th iterative training, J(sₜ,uᵢ(sₜ|Wₐ)|W_{c}) represents the driving behavior cost associated with the network weight W_{c} that is predicted by the evaluation network according to the historical driving environment state sₜ and the estimated driving behavior uᵢ(sₜ|Wₐ); U(sₜ,uₜ) represents the comprehensive driving cost matching the historical driving environment state sₜ and the historical driving action uₜ; Jₛ(sₜ) represent a safety cost of the historical driving environment state sₜ, J_{c}(sₜ) represent a comfort cost of the historical driving environment state sₜ, Jₚ(s) represents a passability cost of the historical driving environment state sₜ, Jᵤ(sₜ,uₜ) represents a secondary quadratic cost matching the historical driving environment state sₜ and the historical driving action, and uₜ, ωₛ, ω_{c}, ωₚ, and ωᵤ are comprehensive cost weight.

Therefore, in this embodiment, through above-mentioned sub-step S251, the multiple iterative optimizations of the evaluation network can be realized in a nest manner in one iterative training of the execution network.

S252: obtaining a target network weight of the execution network in the iterative training by performing a network weight optimization on the execution network based on the plurality of driving network training samples and the evaluation network meeting the iterative optimization termination condition.

In this embodiment, the network weight optimization of the executing network in the i-th iterative training may be expressed using equations of:

$$\{ \begin{matrix}{u}_{i} ( {s}_{t} ) = arg {min}_{u} ( {\sum }_{l = t}^{t + n} U ( {s}_{l} , {u}_{l} ) + {γ}^{t + n + a} {J}_{i}^{*} ( {s}_{t + n + 1} , {u}_{i} ( {s}_{t + n + 1} ) ) ) \\ {u}_{i} ( {s}_{t} ) = {W}_{a}^{T} σ ( {s}_{t} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$

where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, uᵢ(sₜ) represents the estimated driving behavior predicted by the execution network according to the historical driving environment state sₜ when completing the i-th iterative training, U(sₜ,uₜ) represents the comprehensive driving cost matching the historical driving environment state sₜ and the historical driving action uₜ, Jₛ(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state sₜ and the historical driving action uₜ, ωₛ, ω_{c}, ωₚ, and ωᵤ are comprehensive cost weights; uᵢ(sₜ₊ₙ₊₁) represents the estimated driving behavior predicted by the execution network according to the historical driving environment state sₜ₊ₙ₊₁ when completing the i-th iterative training;

$${J}_{i}^{*} ( {s}_{t + n + 1} , {u}_{i} ( {s}_{t + n + 1} ) )$$

represents the driving behavior cost predicted by the evaluation network according to the historical driving environment state sₜ₊ₙ₊₁ and the estimated driving behavior u(sₜ₊ₙ₊₁) when the iteratively optimized termination condition is met during the i-th iterative training; Wₐ represents a to-be-optimized network weight of the execution network; and σ(⋅) representing the tanh activation function.

S253: determining whether the target network weight meets an iterative training termination condition.

In this embodiment, the execution network adopts the same iterative training termination condition for different iterative trainings. The iterative training termination condition may be, for example, the corresponding iterative training times is equal to a preset number of training, or the difference between the driving behavior costs estimated by two adjacent iterative training based on the trained execution network in the same driving environment state

$$( i . e . , {J}_{i}^{*} ( {s}_{t} , {u}_{i} ( {s}_{t} ) ) - {J}_{i - 1}^{*} ( {s}_{t} , {u}_{i - 1} ( {s}_{t} ) ) )$$

is less than a preset cost threshold.

After completing one iterative training for the execution network, the driving decision-making equipment 10 will determine whether the iterative training is the last iterative training by determining whether the target network weight determined by the iterative training meets the iterative training termination condition. In which, if the target network weight determined by this iterative training (i.e., the current iterative training) does not meet the iterative training termination condition, it indicates that this iterative training is not the last iterative training, then the driving decision-making equipment 10 will start to execute the next iterative training for the execution network by jumping to and continuing to perform sub-step S251. At this time, the initial network weight of the execution network in the next iterative training is the target network weight of this iterative training.

Otherwise, if the target network weight determined by this iterative training meets the iterative training termination condition, it is indicated that this iterative training is the last iterative training, then the driving decision-making equipment 10 will execute sub-step S254 accordingly to take the execution network with the target network weight determined by this iterative training as the driving behavior policy network, and at the same time, the evaluation network that meets the iterative optimization termination condition determined in this iterative training is used as the driving cost evaluation network.

S254: directly using the execution network with the target network weight as the driving behavior policy network and using the evaluation network meeting the iterative optimization termination condition in the iterative training as the driving cost evaluation network.

Therefore, in this embodiment, by cyclically performing the above-mentioned sub-steps S251-S254, it can ensure that the final optimized driving behavior policy network and driving cost evaluation network can effectively adapt to the changes in the dynamic traffic environment, and ensure that the driving behavior estimation result output by the corresponding driving behavior policy network for any driving environment state has sufficient accuracy and reliability. At the same time, the corresponding driving cost evaluation network can also accurately evaluate the driving behavior cost caused by any driving environment state and any driving behavior estimation result in a fixed time period of the future.

In addition, in this embodiment, by performing the above-mentioned sub-steps S240-S250, it can ensure that the driving behavior policy network and the driving cost evaluation network can perform model adaptive learning optimization based on the real-time feedback mechanism for the vehicle driving environment information, thereby improving the network reliability and network robustness of the driving behavior policy network and the driving cost evaluation network in a complex driving environment.

In the embodiments of the present disclosure, it should be understood that the disclosed apparatus (device) and method may be implemented in other manners. The above-mentioned apparatus embodiment is merely illustrative, for example, the flow charts and block diagrams in the drawings show the architecture, functions and operations that are possible to be implemented by the apparatus, method and computer program products of the embodiments. In this regard, each block in the flowchart or block diagram may represent a module, a program segment, or a part of codes that include one or more computer executable instructions for implementing specified logical functions. It should also be noted that, in some alternative implementations, the functions noted in the blocks may occur out of the order noted in the figures. For example, two blocks in succession may, in fact, be executed substantially concurrently, or may sometimes be executed in the reverse order, depending upon the functionality involved. It is also to be noted that each block in the block diagrams and/or flow charts, and the combination of blocks in the block diagrams and/or flow charts, may be implemented by a dedicated hardware-based system for performing the specified function or action, or may be implemented by a combination of special purpose hardware and computer instructions.

In addition, each functional module in each of the embodiments of the present disclosure may be integrated to form an independent part, each module or unit may exist independently, or two or more modules or units may be integrated to form an independent part. The functions can be stored in a computer-readable computer readable storage medium if it is implemented in the form of a software functional unit and sold or utilized as a separate product. Based on this understanding, the technical solution of the present disclosure, either essentially or in part, contributes to the prior art, or a part of the technical solution can be embodied in the form of a software product. The software product is stored in a storage medium, which includes a number of instructions for enabling a computer device (which can be a server, an on-board terminal, a personal computer, etc.) for the above-mentioned the driving decision-making equipment 10 to execute all or a part of the steps of the methods described in each of the embodiments of the present disclosure. The above-mentioned storage medium includes a variety of media such as a USB disk, a mobile hard disk, a read-only memory (ROM), a random access memory (RAM), a magnetic disk, and an optical disk which is capable of storing program codes.

The foregoing are only some embodiments of the present disclosure, and are not intended to limit thereto. For those skilled in the art, the present disclosure may have various modifications and variations. Any modifications, equivalent replacements, improvements, and the like made within the spirit and principles of the present disclosure should be included within the scope of the present disclosure.

What is claimed is:

1. A method for deciding an optimal driving action of a target vehicle, comprising:
obtaining an actual driving environment state of the target vehicle at a current moment;
searching, using a driving behavior policy network and a driving cost evaluation network, a Monte Carlo tree according to the actual driving environment state, and determining an optimal sub-node in the Monte Carlo tree that corresponds to a root node in the Monte Carlo tree and meets a minimal driving behavior cost in response to a search termination condition being met; wherein, each of the nodes in the Monte Carlo tree represent a driving environment state, and the root node represents the actual driving environment state; an initial driving behavior cost of each of the node is evaluated by the driving cost evaluation network based on a driving behavior estimation result and the driving environment state of the node, and the driving behavior estimation result of each of the nodes is estimated by the driving behavior policy network based on the driving environment state of the node; and the driving behavior policy network and the driving cost evaluation network are trained based on an adaptive dynamic planning structure; and
taking a driving behavior between the optimal sub-node and the root node as the optimal driving action of the target vehicle at the current moment.

2. The method of claim 1, wherein searching, using the driving behavior policy network and the driving cost evaluation network, the Monte Carlo tree according to the actual driving environment state comprises:
in each search of the Monte Carlo tree, selecting the optimal sub-node in a layer-by-layer manner from the root node based on an actual driving behavior cost and actual access times of each of the nodes in the Monte Carlo tree to determine an optimal node path in the search, wherein a reference driving action of each of the nodes in the Monte Carlo tree is the driving behavior estimation result of the node, and the driving behavior between each of the nodes on the optimal node path other than the root node and a parent node of the node is obtained by adding an action noise to the reference driving action of the parent node;
obtaining a target sub-node by performing sub-node extension on the last node on the optimal node path, and using the driving behavior estimation result of the last node as the reference driving action from the last node to the target sub-node;
performing a driving rehearsal based on the driving environment state and the driving behavior estimation result of the target sub-node, and setting the actual access times of the target sub-node to 1; and
tracing each of the nodes on the optimal node path to update the actual access times and the actual driving behavior cost of the node based on the initial driving behavior cost of the target sub-node.

3. The method of claim 1, further comprising:
obtaining a plurality of driving network training samples, wherein each of the driving network training samples includes a historical driving environment state, a historical driving action, and a comprehensive decayed driving cost of a sample vehicle at a corresponding historical moment, and a historical driving environment state of the sample vehicle at a target moment associated with the historical moment, wherein there are a preset first number of control moments between the target moment and the historical moment, and the comprehensive decayed driving cost is a sum of comprehensive driving cost decays of the sample vehicle at each of a preset second number of continuous control moments since the historical moment, and the preset second number is obtained by adding one from the preset first number; and
obtaining the driving behavior policy network corresponding to the execution network and the driving cost evaluation network corresponding to the evaluation network by performing an iterative training on the adaptive dynamic planning structure including an execution network and an evaluation network based on the plurality of driving network training samples.

4. The method of claim 3, wherein obtaining the driving behavior policy network corresponding to the execution network and the driving cost evaluation network corresponding to the evaluation network by performing the iterative training on the adaptive dynamic planning structure including the execution network and the evaluation network based on the plurality of driving network training samples comprises:
in each iterative training on the execution network, determining an initial network weight of the execution network in the iterative training, and obtaining the evaluation network meeting an iterative optimization termination condition of the iterative training by performing an iterative optimization on the evaluation network based on the initial network weight and the plurality of driving network training samples;
obtaining a target network weight of the execution network in the iterative training by performing a network weight optimization on the execution network based on the plurality of driving network training samples and the evaluation network meeting the iterative optimization termination condition;
determining whether the target network weight meets an iterative training termination condition; and
directly using the execution network with the target network weight as the driving behavior policy network and using the evaluation network meeting the iterative optimization termination condition in the iterative training as the driving cost evaluation network in response to determining that the target network weight meets the iterative training termination condition, and performing a next iterative training on the execution network in response to determining that the target network weight not meets the iterative training termination condition, wherein the initial network weight of the execution network in the next iterative training is the target network weight of the iterative training.

5. The method of claim 4, wherein during each iterative training on the execution network, a network iterative optimization on the evaluation network is performed based on equations of:
$$\{ \begin{matrix}{J}_{j + 1} ( {s}_{t} , {u}_{t} ) = {\sum }_{l = t}^{t + n} U ( {s}_{l} , {u}_{l} ) + {γ}^{n + 1} {J}_{j} ( {s}_{t + n + 1} , u ( {s}_{t + n + 1} ) ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, U(sₜ,uₜ) represents the comprehensive driving cost matching the historical driving environment state sₜ and the historical driving action uₜ, J_{c}(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state sₜ and the historical driving action uₜ, ωₛ, ω_{c}, ωₚ, and ωᵤ are comprehensive cost weights; Jⱼ₊₁(sₜ,uₜ) represents the driving behavior cost predicted by the evaluation network after the j+1-th iterative optimization according to the historical driving environment state sₜ and the historical driving action uₜ, u(sₜ₊ₙ₊₁) represents an estimated driving behavior predicted by the execution network according to the historical driving environment state sₜ₊ₙ₊₁, and Jⱼ(sₜ₊ₙ₊₁,u(sₜ₊ₙ₊₁) represents the driving behavior cost predicted by the evaluation network after the j-th iterative optimization according to the historical driving environment state sₜ₊ₙ₊₁ and the estimated driving behavior u(sₜ₊ₙ₊₁).

6. The method of claim 4, wherein obtaining the evaluation network meeting the iterative optimization termination condition of the iterative training by performing the iterative optimization on the evaluation network based on the initial network weight and the plurality of driving network training samples comprises:
determining a reference network weight of the evaluation network in each iterative optimization on the evaluation network during the iterative training on the execution network;
obtaining a target network weight of the evaluation network in the iterative optimization by performing a network weight update on the evaluation network based on the reference network weight, the initial network weight, and the plurality of driving network trained samples;
determining whether the target network weight meets the iterative optimization termination condition; and
suspending a next iterative optimization and outputting the evaluation network with the target network weight in response to determining that the target network weight meets the iterative optimization termination condition; and performing the next iterative optimization on the evaluation network in response to determining that the target network weight not meets the iterative optimization termination condition; wherein the reference network weight of the evaluation network in the next iterative optimization is the target network weight in the iterative optimization.

7. The method of claim 6, wherein the network weight update of the j+1-th iterative optimization of the evaluation network during the i-th iterative training of the execution network is performed based on equations of:
$$\{ \begin{matrix}{W}_{c , j + 1} = {W}_{c , j} + {α}_{c} \frac{\partial {e}_{j}}{\partial {W}_{c}} \\ {e}_{j} = {\sum }_{l = t}^{t + n} {γ}^{l - t} U ( {s}_{l} , {u}_{i} ( {s}_{l} \vert {W}_{a} ) ) + {γ}^{t + n + 1} J ( {s}_{t + n + 1} , {u}_{i} ( {s}_{t + n + 1} \vert {W}_{a} ) \vert {W}_{c} ) - J ( {s}_{t} , {u}_{i} ( {s}_{t} \vert {W}_{a} ) \vert {W}_{c} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, W_{c,j+1} represent the target network weight of the j+1-th iterative optimization of the evaluation network during the i-th iterative training of the execution network; W_{c,j} represent the target network weight of the j-th iterative optimization of the evaluation network during the i-th iterative training of the execution network, α_{c} represents the learning rate of the evaluation network, W_{c} represents the network weight of the evaluation network, γ represent the discount factor of the evaluation network, sₜ represents the historical driving environment state at the historical moment t, uₜ represents the historical driving action at the historical moment t, sₜ₊ₙ₊₁ represents the historical driving environment state of the target moment associated with the historical moment t, n represents the preset first number, uᵢ(sₜ|Wₐ) represents the estimated driving behavior predicted by the execution network according to the historical driving environment state sₗ using the initial network weight Wₐ during the i-th iterative training, J(sₜ,uᵢ(sₜ|Wₐ)|W_{c}) represents the driving behavior cost associated with the network weight W_{c} that is predicted by the evaluation network according to the historical driving environment state sₜ and the estimated driving behavior uᵢ(sₜ|Wₐ); U(sₜ,uₜ) represents the comprehensive driving cost matching the historical driving environment state sₜ and the historical driving action uₜ; Jₛ(sₜ) represent a safety cost of the historical driving environment state sₜ, J_{c}(sₜ) represent a comfort cost of the historical driving environment state sₜ, Jₚ(s) represents a passability cost of the historical driving environment state sₜ, Jᵤ(sₜ,uₜ) represents a secondary quadratic cost matching the historical driving environment state sₜ and the historical driving action, and uₜ, ωₛ, ω_{c}, ωₚ, and ωᵤ are comprehensive cost weight.

8. The method of claim 4, wherein the network weight optimization on the execution network in the i-th iterative training is performed based on equations of:
$$\{ \begin{matrix}{u}_{i} ( {s}_{t} ) = arg {min}_{u} ( {\sum }_{l = t}^{t + n} U ( {s}_{l} , {u}_{l} ) + {γ}^{t + n + a} {J}_{i}^{*} ( {s}_{t + n + 1} , {u}_{i} ( {s}_{t + n + 1} ) ) ) \\ {u}_{i} ( {s}_{t} ) = {W}_{a}^{T} σ ( {s}_{t} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, uᵢ(sₜ) represents the estimated driving behavior predicted by the execution network according to the historical driving environment state sₜ when completing the i-th iterative training, U(sₜ,uₜ) represents the comprehensive driving cost matching the historical driving environment state sₜ and the historical driving action uₜ, J_{c}(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state and the historical driving action uₜ, ωₛ, ω_{c}, ωₚ, and ωᵤ are comprehensive cost weights; uᵢ(sₜ₊ₙ₊₁) represents the estimated driving behavior predicted by the execution network according to the historical driving environment state sₜ₊ₙ₊₁ when completing the i-th iterative training;
$${J}_{i}^{*} ( {s}_{t + n + 1} , {u}_{i} ( {s}_{t + n + 1} ) )$$
represents the driving behavior cost predicted by the evaluation network according to the historical driving environment state sₜ₊ₙ₊₁ and the estimated driving behavior u(sₜ₊ₙ₊₁) when the iteratively optimized termination condition is met during the i-th iterative training; Wₐ represents a to-be-optimized network weight of the execution network; and σ(⋅) representing the tanh activation function.

9. A driving decision-making equipment, comprising:
a processor;
a memory coupled to the processor; and
one or more computer programs stored in the memory and executable on the processor;
wherein, the one or more computer programs comprise:
instructions for obtaining an actual driving environment state of a target vehicle at a current moment;
instructions for searching, using a driving behavior policy network and a driving cost evaluation network, a Monte Carlo tree according to the actual driving environment state, and determining an optimal sub-node in the Monte Carlo tree that corresponds to a root node in the Monte Carlo tree and meets a minimal driving behavior cost in response to a search termination condition being met; wherein, each of the nodes in the Monte Carlo tree represent a driving environment state, and the root node represents the actual driving environment state; an initial driving behavior cost of each of the node is evaluated by the driving cost evaluation network based on a driving behavior estimation result and the driving environment state of the node, and the driving behavior estimation result of each of the nodes is estimated by the driving behavior policy network based on the driving environment state of the node; and the driving behavior policy network and the driving cost evaluation network are trained based on an adaptive dynamic planning structure; and
instructions for taking a driving behavior between the optimal sub-node and the root node as an optimal driving action of the target vehicle at the current moment.

10. The equipment of claim 9, the instructions for searching, using the driving behavior policy network and the driving cost evaluation network, the Monte Carlo tree according to the actual driving environment state comprise:
instructions for, in each search of the Monte Carlo tree, selecting the optimal sub-node in a layer-by-layer manner from the root node based on an actual driving behavior cost and actual access times of each of the nodes in the Monte Carlo tree to determine an optimal node path in the search, wherein a reference driving action of each of the nodes in the Monte Carlo tree is the driving behavior estimation result of the node, and the driving behavior between each of the nodes on the optimal node path other than the root node and a parent node of the node is obtained by adding an action noise to the reference driving action of the parent node;
instructions for obtaining a target sub-node by performing sub-node extension on the last node on the optimal node path, and using the driving behavior estimation result of the last node as the reference driving action from the last node to the target sub-node;
instructions for performing a driving rehearsal based on the driving environment state and the driving behavior estimation result of the target sub-node, and setting the actual access times of the target sub-node to 1; and
instructions for tracing each of the nodes on the optimal node path to update the actual access times and the actual driving behavior cost of the node based on the initial driving behavior cost of the target sub-node.

11. The equipment of claim 9, the one or more computer programs comprise further comprise:
instructions for obtaining a plurality of driving network training samples, wherein each of the driving network training samples includes a historical driving environment state, a historical driving action, and a comprehensive decayed driving cost of a sample vehicle at a corresponding historical moment, and a historical driving environment state of the sample vehicle at a target moment associated with the historical moment, wherein there are a preset first number of control moments between the target moment and the historical moment, and the comprehensive decayed driving cost is a sum of comprehensive driving cost decays of the sample vehicle at each of a preset second number of continuous control moments since the historical moment, and the preset second number is obtained by adding one from the preset first number; and
instructions for obtaining the driving behavior policy network corresponding to the execution network and the driving cost evaluation network corresponding to the evaluation network by performing an iterative training on the adaptive dynamic planning structure including an execution network and an evaluation network based on the plurality of driving network training samples.

12. The equipment of claim 11, wherein the instructions for obtaining the driving behavior policy network corresponding to the execution network and the driving cost evaluation network corresponding to the evaluation network by performing the iterative training on the adaptive dynamic planning structure including the execution network and the evaluation network based on the plurality of driving network training samples comprise:
instructions for, in each iterative training on the execution network, determining an initial network weight of the execution network in the iterative training, and obtaining the evaluation network meeting an iterative optimization termination condition of the iterative training by performing an iterative optimization on the evaluation network based on the initial network weight and the plurality of driving network training samples;
instructions for obtaining a target network weight of the execution network in the iterative training by performing a network weight optimization on the execution network based on the plurality of driving network training samples and the evaluation network meeting the iterative optimization termination condition;
instructions for determining whether the target network weight meets an iterative training termination condition; and
instructions for directly using the execution network with the target network weight as the driving behavior policy network and using the evaluation network meeting the iterative optimization termination condition in the iterative training as the driving cost evaluation network in response to determining that the target network weight meets the iterative training termination condition, and performing a next iterative training on the execution network in response to determining that the target network weight not meets the iterative training termination condition, wherein the initial network weight of the execution network in the next iterative training is the target network weight of the iterative training.

13. The equipment of claim 12, wherein during each iterative training on the execution network, a network iterative optimization on the evaluation network is performed based on equations of:
$$\{ \begin{matrix}{J}_{j + 1} ( {s}_{t} , {u}_{t} ) = {\sum }_{l = t}^{t + n} U ( {s}_{l} , {u}_{l} ) + {γ}^{n + 1} {J}_{j} ( {s}_{t + n + 1} , u ( {s}_{t + n + 1} ) ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, U(sₜ,uₜ) represents the comprehensive driving cost matching the historical driving environment state sₜ and the historical driving action uₜ, Jₛ(sₜ) represent a safety cost of the historical driving environment state sₜ, J_{c}(sₜ) represent a comfort cost of the historical driving environment state sₜ, J_{c}(sₜ) represents a passability cost of the historical driving environment state sₜ, J_{c}(sₜ,uₜ) represents a secondary quadratic cost matching the historical driving environment state sₜ and the historical driving action uₜ, ωₛ, ω_{c}, ωₚ, and ωᵤ are comprehensive cost weights; Jⱼ₊₁(sₜ,uₜ) represents the driving behavior cost predicted by the evaluation network after the j+1-th iterative optimization according to the historical driving environment state sₜ and the historical driving action uₜ, u(sₜ₊ₙ₊₁) represents an estimated driving behavior predicted by the execution network according to the historical driving environment state sₜ₊ₙ₊₁, and J(sₜ₊ₙ₊₁,u(sₜ₊ₙ₊₁) represents the driving behavior cost predicted by the evaluation network after the j-th iterative optimization according to the historical driving environment state sₜ₊ₙ₊₁ and the estimated driving behavior u(sₜ₊ₙ₊₁).

14. The equipment of claim 12, wherein instructions for obtaining the evaluation network meeting the iterative optimization termination condition of the iterative training by performing the iterative optimization on the evaluation network based on the initial network weight and the plurality of driving network training samples comprise:
instructions for determining a reference network weight of the evaluation network in each iterative optimization on the evaluation network during the iterative training on the execution network;
instructions for obtaining a target network weight of the evaluation network in the iterative optimization by performing a network weight update on the evaluation network based on the reference network weight, the initial network weight, and the plurality of driving network trained samples;
instructions for determining whether the target network weight meets the iterative optimization termination condition; and
instructions for suspending a next iterative optimization and outputting the evaluation network with the target network weight in response to determining that the target network weight meets the iterative optimization termination condition; and performing the next iterative optimization on the evaluation network in response to determining that the target network weight not meets the iterative optimization termination condition; wherein the reference network weight of the evaluation network in the next iterative optimization is the target network weight in the iterative optimization.

15. The equipment of claim 14, wherein the network weight update of the j+1-th iterative optimization of the evaluation network during the i-th iterative training of the execution network is performed based on equations of:
$$\{ \begin{matrix}{W}_{c , j + 1} = {W}_{c , j} + {α}_{c} \frac{\partial {e}_{j}}{\partial {W}_{c}} \\ {e}_{j} = {\sum }_{l = t}^{t + n} {γ}^{l - t} U ( {s}_{l} , {u}_{i} ( {s}_{l} \vert {W}_{a} ) ) + {γ}^{t + n + 1} J ( {s}_{t + n + 1} , {u}_{i} ( {s}_{t + n + 1} \vert {W}_{a} ) \vert {W}_{c} ) - J ( {s}_{t} , {u}_{i} ( {s}_{t} \vert {W}_{a} ) \vert {W}_{c} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, W_{c,j+1} represent the target network weight of the j+1-th iterative optimization of the evaluation network during the i-th iterative training of the execution network; W_{c,j} represent the target network weight of the j-th iterative optimization of the evaluation network during the i-th iterative training of the execution network, α_{c} represents the learning rate of the evaluation network, W_{c} represents the network weight of the evaluation network, γ represent the discount factor of the evaluation network, sₜ represents the historical driving environment state at the historical moment t, uₜ represents the historical driving action at the historical moment t, sₜ₊ₙ₊₁ represents the historical driving environment state of the target moment associated with the historical moment t, n represents the preset first number, uᵢ(sₜ|Wₐ) represents the estimated driving behavior predicted by the execution network according to the historical driving environment state sₗ using the initial network weight Wₐ during the i-th iterative training, J(sₜ,uᵢ(sₜ|Wₐ)|W_{c}) represents the driving behavior cost associated with the network weight W_{c} that is predicted by the evaluation network according to the historical driving environment state sₜ and the estimated driving behavior uᵢ(sₜ|Wₐ); U(sₜ,uₜ) represents the comprehensive driving cost matching the historical driving environment state sₜ and the historical driving action uₜ; Jₛ(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state sₜ and the historical driving action, and uₜ, ωₛ, ω_{c}, ωₚ, and ωᵤ are comprehensive cost weight.

16. The equipment of claim 12, wherein the network weight optimization on the execution network in the i-th iterative training is performed based on equations of:
$$\{ \begin{matrix}{u}_{i} ( {s}_{t} ) = arg {min}_{u} ( {\sum }_{l = t}^{t + n} U ( {s}_{l} , {u}_{l} ) + {γ}^{t + n + a} {J}_{i}^{*} ( {s}_{t + n + 1} , {u}_{i} ( {s}_{t + n + 1} ) ) ) \\ {u}_{i} ( {s}_{t} ) = {W}_{a}^{T} σ ( {s}_{t} ) \\ U ( {s}_{t} , {u}_{t} ) = {ω}_{s} {J}_{s} ( {s}_{t} ) + {ω}_{c} {J}_{c} ( {s}_{t} ) + {ω}_{p} {J}_{p} ( {s}_{t} ) + {ω}_{u} {J}_{u} ( {s}_{t} , {u}_{t} )\end{matrix} ;$$
where, γ represents a discount factor of the evaluation network, sₜ represents the historical driving environment state at a historical moment t, uₜ represents the historical driving action at the historical moment t, sₜ₊ₙ₊₁ represents the historical driving environment state of the target moment associated with the historical moment t, n represents the preset first number, uᵢ(sₜ) represents the estimated driving behavior predicted by the execution network according to the historical driving environment state sₜ when completing the i-th iterative training, U(sₜ,uₜ) represents the comprehensive driving cost matching the historical driving environment state sₜ and the historical driving action uₜ, Jₛ(sₜ) represent a safety cost of the historical driving environment state sₜ, J_{c}(sₜ) represent a comfort cost of the historical driving environment state sₜ, Jₚ(sₜ) represents a passability cost of the historical driving environment state sₜ, Jᵤ(sₜ,uₜ) represents a secondary quadratic cost matching the historical driving environment state sₜ and the historical driving action uₜ, ωₛ, ω_{c}, ωₚ, and ωᵤ are comprehensive cost weights; U(sₜ₊ₙ₊₁) represents the estimated driving behavior predicted by the execution network according to the historical driving environment state sₜ₊ₙ₊₁ when completing the i-th iterative training;
$${J}_{i}^{*} ( {s}_{t + n + 1} , {u}_{i} ( {s}_{t + n + 1} ) )$$
represents the driving behavior cost predicted by the evaluation network according to the historical driving environment state sₜ₊ₙ₊₁ and the estimated driving behavior u(sₜ₊ₙ₊₁) when the iteratively optimized termination condition is met during the i-th iterative training; Wₐ represents a to-be-optimized network weight of the execution network; and σ(⋅) representing the tanh activation function.

17. A non-transitory computer-readable storage medium for storing one or more computer programs, wherein the one or more computer programs comprise:
instructions for obtaining an actual driving environment state of a target vehicle at a current moment;
instructions for searching, using a driving behavior policy network and a driving cost evaluation network, a Monte Carlo tree according to the actual driving environment state, and determining an optimal sub-node in the Monte Carlo tree that corresponds to a root node in the Monte Carlo tree and meets a minimal driving behavior cost in response to a search termination condition being met; wherein, each of the nodes in the Monte Carlo tree represent a driving environment state, and the root node represents the actual driving environment state; an initial driving behavior cost of each of the node is evaluated by the driving cost evaluation network based on a driving behavior estimation result and the driving environment state of the node, and the driving behavior estimation result of each of the nodes is estimated by the driving behavior policy network based on the driving environment state of the node; and the driving behavior policy network and the driving cost evaluation network are trained based on an adaptive dynamic planning structure; and
instructions for taking a driving behavior between the optimal sub-node and the root node as an optimal driving action of the target vehicle at the current moment.

18. The storage medium of claim 17, the instructions for searching, using the driving behavior policy network and the driving cost evaluation network, the Monte Carlo tree according to the actual driving environment state comprise:
instructions for, in each search of the Monte Carlo tree, selecting the optimal sub-node in a layer-by-layer manner from the root node based on an actual driving behavior cost and actual access times of each of the nodes in the Monte Carlo tree to determine an optimal node path in the search, wherein a reference driving action of each of the nodes in the Monte Carlo tree is the driving behavior estimation result of the node, and the driving behavior between each of the nodes on the optimal node path other than the root node and a parent node of the node is obtained by adding an action noise to the reference driving action of the parent node;
instructions for obtaining a target sub-node by performing sub-node extension on the last node on the optimal node path, and using the driving behavior estimation result of the last node as the reference driving action from the last node to the target sub-node;
instructions for performing a driving rehearsal based on the driving environment state and the driving behavior estimation result of the target sub-node, and setting the actual access times of the target sub-node to 1; and
instructions for tracing each of the nodes on the optimal node path to update the actual access times and the actual driving behavior cost of the node based on the initial driving behavior cost of the target sub-node.

19. The storage medium of claim 17, the one or more computer programs comprise further comprise:
instructions for obtaining a plurality of driving network training samples, wherein each of the driving network training samples includes a historical driving environment state, a historical driving action, and a comprehensive decayed driving cost of a sample vehicle at a corresponding historical moment, and a historical driving environment state of the sample vehicle at a target moment associated with the historical moment, wherein there are a preset first number of control moments between the target moment and the historical moment, and the comprehensive decayed driving cost is a sum of comprehensive driving cost decays of the sample vehicle at each of a preset second number of continuous control moments since the historical moment, and the preset second number is obtained by adding one from the preset first number; and
instructions for obtaining the driving behavior policy network corresponding to the execution network and the driving cost evaluation network corresponding to the evaluation network by performing an iterative training on the adaptive dynamic planning structure including an execution network and an evaluation network based on the plurality of driving network training samples.

20. The storage medium of claim 19, wherein the instructions for obtaining the driving behavior policy network corresponding to the execution network and the driving cost evaluation network corresponding to the evaluation network by performing the iterative training on the adaptive dynamic planning structure including the execution network and the evaluation network based on the plurality of driving network training samples comprise:
instructions for, in each iterative training on the execution network, determining an initial network weight of the execution network in the iterative training, and obtaining the evaluation network meeting an iterative optimization termination condition of the iterative training by performing an iterative optimization on the evaluation network based on the initial network weight and the plurality of driving network training samples;
instructions for obtaining a target network weight of the execution network in the iterative training by performing a network weight optimization on the execution network based on the plurality of driving network training samples and the evaluation network meeting the iterative optimization termination condition;
instructions for determining whether the target network weight meets an iterative training termination condition; and
instructions for directly using the execution network with the target network weight as the driving behavior policy network and using the evaluation network meeting the iterative optimization termination condition in the iterative training as the driving cost evaluation network in response to determining that the target network weight meets the iterative training termination condition, and performing a next iterative training on the execution network in response to determining that the target network weight not meets the iterative training termination condition, wherein the initial network weight of the execution network in the next iterative training is the target network weight of the iterative training.
